(19) United States
(12) Patent Application Publication
(10) Pub. No.: US 2025/0189150 A1
(43) Pub. Date: Jun. 12, 2025

(54) WET AIR FILTRATION DEVICE

(71) Applicant: Air Clarity Solutions Inc., Oromocto (CA)

(72) Inventor: Michael William Douglas RUSHTON, Oromocto (CA)

(21) Appl. No.: 18/535,757

(22) Filed: Dec. 11, 2023

(51) Int. Cl. F24F 8/133; B01D 47/00; F24F 8/183

(52) U.S. Cl. CPC F24F 8/133; B01D 47/00; F24F 8/183; B01D 2247/101; B01D 2247/108; B01D 2247/14

(57) ABSTRACT

Air filtration devices are described for wet air filtration. In exemplary embodiments, an air filtration device includes a housing having an air intake and an air outlet. An air conduit extends between the air intake and the air outlet. A fan is positioned in the air conduit and configured to draw air into the device via the air intake and propel the air through an air channel towards the air outlet. The air conduit includes a liquid introduction section configured to introduce a liquid to the air in the air channel, and a liquid removal section configured to guide the air in a downward helical path downstream of the liquid introduction section configured to separate the liquid from the air using centrifugal force.

### FIELD

The present disclosure is related to methods and systems for air filtration and particularly, a water-based air filtration system for cleaning air.

### BACKGROUND

Air filtration devices can be classified as either dry air filtration devices or wet air filtration devices. Traditional dry air filtration devices may remove impurities and other particulates (e.g., dust, pollen, mold etc.) from the air by capturing the particles within a fibrous or porous filter, or using electrostatic precipitation. Wet air filtration devices may rely on water for removing impurities from the air, for example, using spray technologies to introduce a jet of water through a nozzle at high pressures for capturing and precipitating particulates in the air. Wet filtration devices may also rely on energy-intensive processes to draw the mixture of water and air through water-filtration membranes, often requiring special vacuum pump, dredging, or conveyor belt systems to remove sludge and rendering the devices as large and bulky, costly to operate and complex.

Accordingly, there is a need for improved wet air filtration devices.

### SUMMARY

In a first aspect of the present disclosure, there is provided an air filtration device comprising: a housing having an air intake and an air outlet; an air conduit extending between the air intake and the air outlet; and a fan positioned in the air conduit and configured to draw air into the device via the air intake and propel the air through an air channel towards the air outlet, wherein the air conduit includes a liquid introduction section configured to introduce a liquid to the air in the air channel, and a liquid removal section configured to guide the air in a downward helical path downstream of the liquid introduction section to separate the liquid from the air using centrifugal force.

In some or all exemplary embodiments of the first aspect, the air filtration device can include a reservoir positioned above the liquid introduction section, the reservoir having a plurality of apertures configured to allow the fluid to precipitate from the reservoir into the air in the air channel.

In some or all exemplary embodiments of the first aspect, the reservoir is tapered towards an upper end thereof.

In some or all exemplary embodiments of the first aspect, the reservoir includes at least one aperture or gap towards opposite interior lateral sides of the air conduit configured to allow the liquid to flow along the interior lateral sides of the conduit.

In some or all exemplary embodiments of the first aspect, the reservoir includes a diffusion plate positioned adjacent to the air channel having the at least one aperture.

In some or all exemplary embodiments of the first aspect, the plurality of apertures are positioned to introduce the liquid into the liquid introduction section of the air conduit in which the air is moved substantially upwards.

In some or all exemplary embodiments of the first aspect, a bypass section extends from the liquid introduction section spaced from the plurality of apertures, and to the liquid removal section.

In some or all exemplary embodiments of the first aspect, an ingress of the bypass section from the liquid introduction section has a cross section that is greater than a cross section of the liquid introduction section.

In some or all exemplary embodiments of the first aspect, a drain conduit extends from a lower end of the liquid introduction section to return the liquid removed from the air in the liquid introduction section to the liquid tank.

In some or all exemplary embodiments of the first aspect, a liquid tank is positioned to receive the liquid separated from the air, and a pump is configured to draw the liquid from the liquid tank and into the reservoir.

In some or all exemplary embodiments of the first aspect, the liquid tank is removable from the housing.

In some or all exemplary embodiments of the first aspect, the liquid tank includes a baffle separating a dirty water area from a clarified water area, the baffle is configured to allow the liquid towards the top of the dirty liquid area to flow into the clarified liquid area, and a pump is positioned in the clarified liquid area to move the liquid therein to the reservoir.

In some or all exemplary embodiments of the first aspect, the air filtration device includes a silt sensor positioned to measure a silt level in the liquid in the liquid tank.

In some or all exemplary embodiments of the first aspect, the air filtration device includes an audio or visual notification device configured to notify when the silt level is at least at a threshold value.

In some or all exemplary embodiments of the first aspect, the air filtration device includes a wireless communications module configured to transmit a notification when the silt level is at least at a threshold value.

In some or all exemplary embodiments of the first aspect, the air channel defined by the air conduit extends downwardly from the air intake.

In some or all exemplary embodiments of the first aspect, the liquid introduction section defines an upward path for the air travelling in the air channel from the air intake to the air outlet.

In some or all exemplary embodiments of the first aspect, a drain conduit extends from a lower end of the liquid removal section to return the liquid removed from the air in the liquid removal section to the liquid tank.

In some or all exemplary embodiments of the first aspect, the plurality of apertures are positioned to introduce the liquid into the liquid introduction section of the air conduit in which the air is moved substantially upwards, wherein a drain conduit extends from a lower end of the liquid introduction section to return the liquid removed from the air in the liquid introduction section to the liquid tank, and wherein the drain conduit extending from a lower end of the liquid removal section is joined to the drain conduit extending from a lower end of the liquid removal section via a one-way check valve to maintain a vacuum seal.

In some or all exemplary embodiments of the first aspect, the liquid removal section includes a chamber having an arcuate interior wall configured to direct the air along a helical path.

In some or all exemplary embodiments of the first aspect, an exhaust conduit extends centrally from the air outlet downwards in the chamber, and has an opening towards a lower end thereof configured to receive the air.

In some or all exemplary embodiments of the first aspect, the liquid tank includes a baffle defining a dirty liquid section and a clarified liquid section, wherein the liquid separated from the air is returned to the dirty liquid section of the liquid tank, and wherein the baffle is configured to allow the liquid in the dirty liquid section to overflow into the clarified liquid section.

In some or all exemplary embodiments of the first aspect, the air filtration device includes a set of wheels connected to the housing configured to facilitate relocation of the air filtration device.

In some or all exemplary embodiments of the first aspect, the air filtration device can include a duct adapter for securely coupling a duct to one of the air intake and the air outlet.

### BRIEF DESCRIPTION OF THE DRAWINGS

Reference will now be made, by way of example, to the accompanying drawings which show example embodiments of the present application, and in which:

FIG. 1 shows a top, front, right side isometric view of a wet air filtration device in accordance with an example embodiment of the present disclosure.

FIG. 2 shows the wet air filtration device of FIG. 1, shown without external plating, in accordance with examples of the present disclosure.

FIG. 3 shows a front elevation view of the wet air filtration device of FIGS. 1 and 2.

FIG. 4 shows a right side elevation view of the wet air filtration device of FIGS. 1 to 3.

FIG. 5 is a cross section view of the wet air filtration device along line 5-5 of FIG. 4.

FIG. 6 is a cross section view along line 6-6 of FIG. 4.

FIG. 7 shows a back view of the wet air filtration device of FIGS. 1 to 4 without external plating.

FIG. 8 shows a top, rear, right side isometric view of a wet air filtration device in accordance with another exemplary embodiment of the present disclosure.

FIG. 9 shows the wet air filtration device of FIG. 8 without external plating.

FIG. 10 shows a rear elevation view of the wet air filtration device of FIGS. 8 and 9 without external plating.

FIG. 11 shows a right side elevation view of the wet air filtration device of FIGS. 8 to 10 without external plating.

FIG. 12 is a cross section view of the wet air filtration device of FIGS. 8 to 11 along line 12-12 of FIG. 11.

FIG. 13 is a cross section view of the wet air filtration device of FIGS. 8 to 11 along line 13-13 of FIG. 11.

FIG. 14 shows a back view of the wet air filtration device of FIGS. 8 to 11 without external plating.

FIG. 15 shows a top, front, right side isometric view of a wet air filtration device in accordance with a further example embodiment of the present disclosure.

FIG. 16 shows a duct adapter used to connect ducts to the wet air filtration device of FIG. 15.

Similar reference numerals may have been used in different figures to denote similar components. Unless otherwise specifically noted, articles depicted in the drawings are not necessarily drawn to scale.

### DETAILED DESCRIPTION

The following describes example technical solutions of this disclosure with reference to accompanying drawings. Similar reference numerals may have been used in different figures to denote similar components.

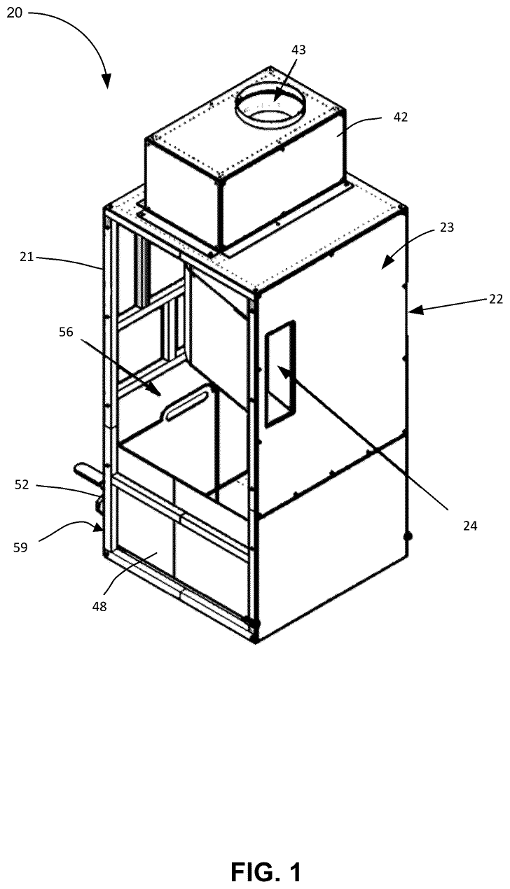

FIG. 1 shows an air filtration device 20 in accordance with an exemplary embodiment. Particle-polluted air is drawn into a separator of the wet air filtration device 20 via suction through a dirty-air intake 24 for cleaning or treating to remove pollutants and/or other unwanted particulates. A fan unit 42 draws the dirty air in through the dirty-air intake 24 and expels treated air through a clean air outlet 43. In examples, the treated air has reduced levels of pollutants in comparison to the input air stream.

The air filtration device 20 has a housing 23 that includes a frame 21 to which external plates 22 are secured. The external plates 22 can be made of, for example, rigid plastic or sheet metal, among other materials. In some embodiments, a full view window 56, for example, a Lexan™ polycarbonate resin thermoplastic window, enables viewing of the interior of the air filtration device 20. In other embodiments, for example, the window 56 can alternatively be replaced by a sheet metal panel or other material. Particle-laden ambient air, alternatively referred to herein as “dirty air”, is drawn into the air filtration device 20 via an air intake 24 and filtered air exits the air filtration device 20 via an air outlet 43.

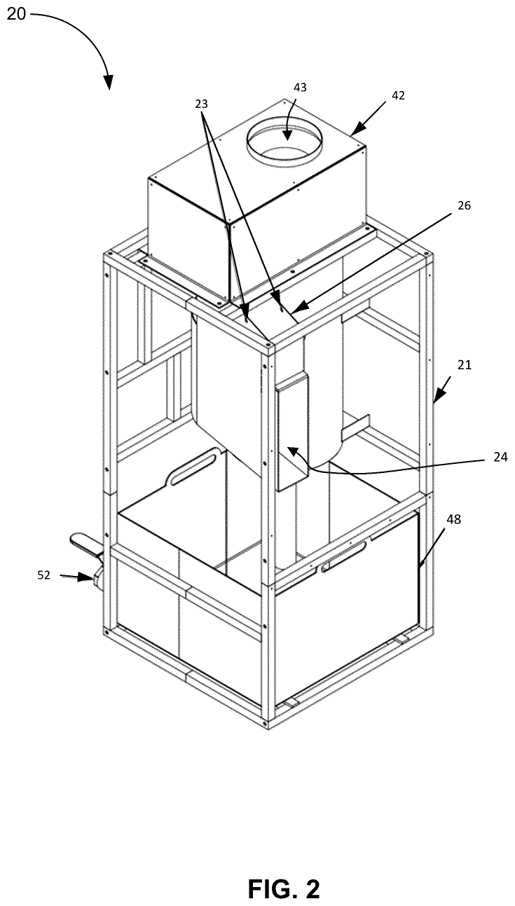

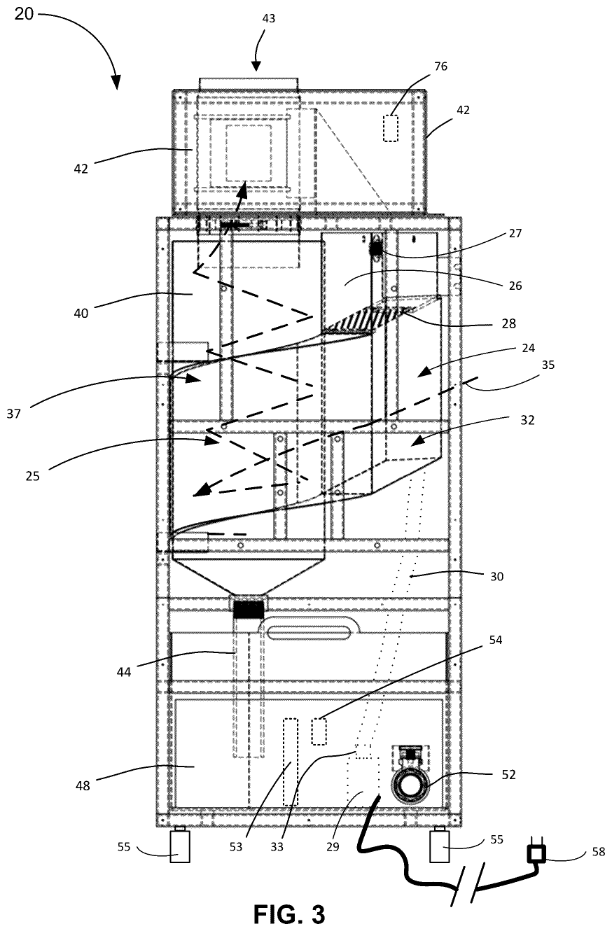

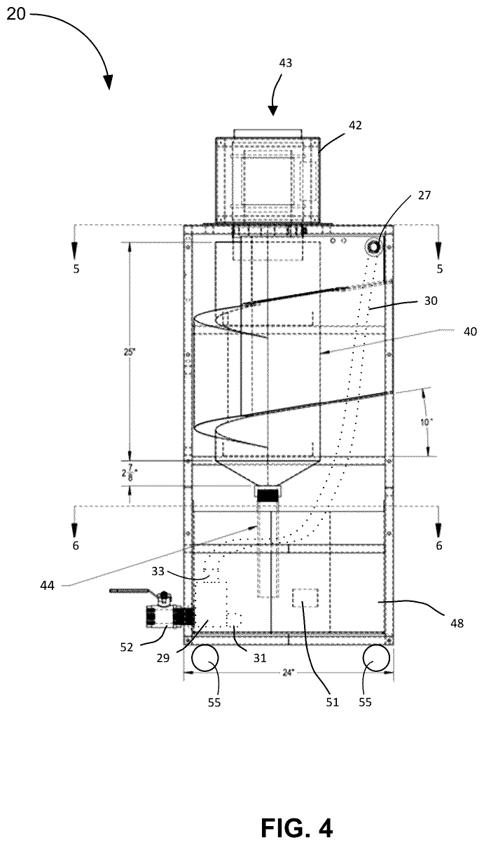

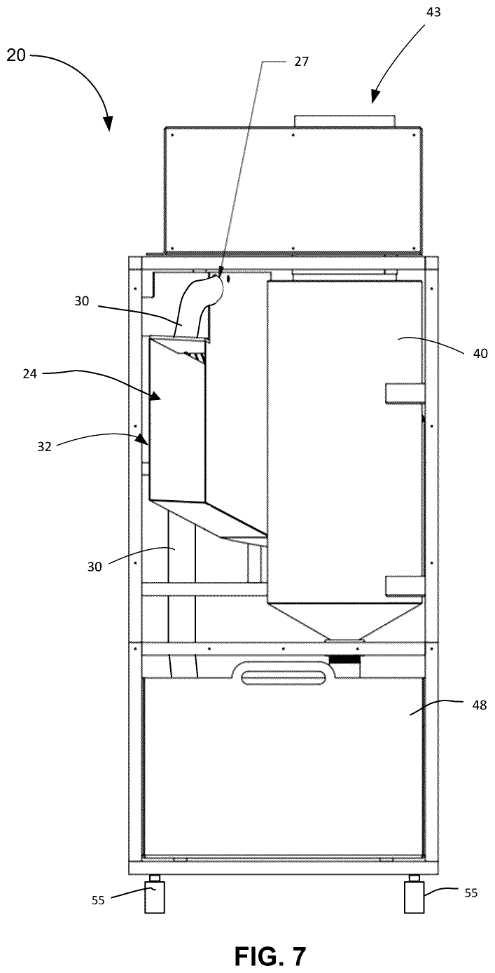

FIGS. 2 to 7 show the air filtration device 20 of FIG. 1 without the external plates 22.

With reference now to FIGS. 1 to 7, the dirty air is drawn into the air intake 24 and through an air conduit 25 extending between the air intake 24 and the air outlet 43 via a fan unit 42 that is positioned therein. The air conduit 25 defines an air channel through which the air flows along a path 35 from the air intake 24 to the air outlet 43. The air conduit 25 can be made of any suitable material or materials that are sufficiently durable and rigid, and can withstand high levels of humidity. The fan unit 42 is positioned in the air conduit 25 towards the air outlet 43 so that it is not subject to the humidity of the air upstream in the air channel before the water droplets are encouraged to separate from the air. In other embodiments, it may be desirable to move the position of the fan unit along the air conduit.

The air channel defined by the air conduit 25 extends downwardly from the air intake 24 to the liquid introduction section 32 to prevent leaking and/or discharge of water from the air intake 24. In other embodiments, however, the air conduit can extend from the air intake in any suitable manner. In the liquid introduction section 32, water is mixed with the particle-laden air drawn in through the air intake 24 to entrap airborne particles in the water droplets. A downstream fluid removal section 37 is designed to encourage the particle-laden water to separate from the air before the air is discharged back into the environment.

Water is introduced to the air in the air channel within the liquid introduction section 32 as precipitation from a reservoir 26 positioned above the air conduit 25. The reservoir 26 is fed water from a water storage tank 48 positioned towards the lower end of the air filtration device 20 via a hose 30 connected to a pump 29. In examples, reservoir 26 may include overflow ports 23 to prevent overfilling of the reservoir 26. The bottom surface of the reservoir 26 is provided by a removable diffusion plate 28 that has a plurality of apertures for enabling water in the reservoir 26 to precipitate passively from the reservoir 26 down through the air channel as a result of gravity. In examples, the apertures may be circular or formed in other shapes. In one particular configuration, for example, the diffusion plate 28 may be configured to include 19 rows of one-eighth inch apertures, but other configurations may be used. The diffusion plate 28 may include apertures comprising both slots and holes for mixed fluid dynamics. Water droplets that are not carried by the air in the air channel 25 run down a bottom surface of the air conduit 25 downstream.

Gaps are provided along opposing lateral sides of the diffusion plate 28 adjacent to side walls of the air conduit 25. The gaps can be continuous or can be broken. The gaps enable treatment water to flow down the side walls of the air conduit 25 in the liquid introduction section for cleaning, and to discourage particles from adhering to the side walls of the air conduit 25. In some embodiments, the diffusion plate 28 may be provided with a self-cleaning and/or non-clogging mechanism to maintain the ability for water in the reservoir 26 to enter the liquid introduction section 32 of the air conduit 25.

During operation, the fluid reservoir 26 is maintained at least partially full and the apertures of the diffusion plate 28 are preferably sized to have the surface tension of the water inhibit the water being drawn by the fan unit 42.

Particles in the air, when the air passes through the liquid introduction section 32, come into contact with the water droplets and become entrapped therein, thereby removing the particles from the air. In addition, some of the water may be vaporized and carried with the air.

The air mixed with the water droplets in the liquid introduction section 32 is then guided via the air conduit 25 to a lower portion of the cyclonic chamber 40. The air then follows a generally helical path upwards in the cyclonic chamber 40. During travel of the air along the helical path, centrifugal force encourages the particle-laden water droplets and the vapor outwards towards the walls of the cyclonic chamber 40 to which the water droplets and droplets formed from the condensing water vapor cling. The water droplets and the vapor cast onto the walls of the cyclonic chamber 40 then run down the walls of the cyclonic chamber 40 towards a drain at the bottom end thereof connected to a cyclonic chamber drain pipe 44. The cyclonic chamber drain pipe returns the particle-laden water back to the tank 48 for recycling.

As the air travels upwardly in the cyclonic chamber 40, particle-laden water droplets are removed, allowing relatively clean air to be directed out of the air outlet 43 at the top of the air filtration device 20.

In other example configurations, the water may be permitted to accumulate at the bottom of the cyclonic chamber.

The tank 48 facilitates the clarification of dirty treatment water to produce clarified treatment water for re-use in the air filtration device 20. In particular, the dirty treatment water received from the cyclonic chamber 40 may undergo a settling process within the water storage tank 48, for example, for separating pollutants via gravity separation from the dirty treatment water. In examples, a froth or scum may also form on the surface of the dirty treatment water in the water storage tank 48, for example, for separating pollutants or other particles from the dirty treatment water.

The water storage tank includes a baffle 50 that divides the fluid storage space of the water storage tank 48 into a dirty water area 46 and a clarified water area 47. The baffle 50 is sealed against lateral sides of the water storage tank 48 to prevent water leakage along the sides or the bottom of the baffle 50. The contaminated water from the cyclonic chamber 40 is received in the dirty water area 46 via the cyclonic chamber 40 drain pipe 44, and the particulate settles along its bottom. The outlet of the cyclone chamber drain pipe 44 is configured to be continually submerged in the dirty water area 46 of the water storage tank 48 for ensuring a vacuum seal within the closed-loop plumbing system of the air filtration device 20 to minimize disturbance to settling processes in the dirty water area 46, or to reduce stirring up the settled pollutants or other particles. Pollutants or other particles within the dirty treatment water settle on the bottom of the dirty water area 46 of the water storage tank 48 in the form of sludge. As a result, the water towards its surface being relatively clarified. A spillover opening 51 enables spillover of the clarified water from the dirty water area 46 into the clarified water area 47.

The sludge may be stored within the water storage tank 48 for removal when necessary. The water storage tank 48 is removable from the housing of the air filtration device 20 to facilitate cleaning of the sludge from the bottom of the water storage tank 48. In examples, the amount of time until the sludge needs to be cleaned may be guided by a pre-defined settling time, ambient air quality, relative and/or absolute ambient humidity, and/or flow rates. The treatment water may be reused within the air filtration device 20 until the treatment water quality reaches a pre-defined quality threshold, for example, based on the operating parameters of the pump 29. In other examples, the treatment water may be reused within the device 20 for a pre-determined time duration, or until an amount of sludge deposited on the bottom of the water storage tank 48 reaches a threshold, among other criteria. In examples, the drain valve 52 enables draining of the water storage tank 48 and an access panel 59 facilitates removal of the water storage tank 48 for emptying and cleaning.

A sensor 53 for detecting water quality and silt level, among other parameters, may be used to indicate a threshold has been reached. The sensor can be optical or any other suitable type of sensor for detecting water quality and/or silt level. A wireless communications module 54 is configured to retrieve sensor data from the sensor 53, including the water quality and silt level, and communicate it via a wireless communications standard such as 802.11, Bluetooth, LTE, or any other suitable wireless communications standard for conveying the sensor data to another system. In one configuration, the wireless communications module 54 intermittently transmits the sensor data to another system for reporting. In another configuration, the wireless communications module 54 is configured to communicate the sensor data upon the exceeding of a threshold, such as a maximum silt level or water quality level. In addition, a light indicator and audio speaker 76 are connected to the sensor 53 for indicating a status of the air filtration device 20. The light indicator can be illuminated with a green light when the air filtration device 20 is operating normally, and an amber or red light when the air filtration device 20 is not operating normally, such as when the silt level exceeds a threshold. The audio speaker can indicate the status of the air filtration device 20 and emit an audible alarm when the air filtration device 20 is not operating properly, such as when the silt level is at or above a threshold.

A drain valve 52 is provided to drain the water from the clarified water area 47 of the water storage tank 48 prior to its removal for cleaning. Of note is that the water and sludge in the dirty water area 46 is not drained via the drain valve 52 and remains in the water storage tank 48 until the water storage tank 48 is removed and cleaned.

The pump for providing water from the water storage tank 48 to the reservoir 26 has a pump intake 31 that is positioned in the clarified water area 47 to prevent clogging of the plumbing system and improve the performance of the water to entrap particulate. In examples, the spillover opening 51 may be positioned horizontally in the baffle 50 to correspond with the formation of the layer of clarified treatment water in the dirty treatment water. In some embodiments, for example, the spillover opening 51 may be configured in an upper portion of the baffle 50 to enable clarified treatment water to flow from the dirty water area 46 into the clarified water area 47. Other configurations may also be used.

The pump 29 is connected to a hose 30 that extends upwardly to a pump outlet 33. The pump outlet 33 is connected to the reservoir 26 to provide clarified water from the clarified water area 47 of the water storage tank 48. In examples, the clarified water may be transported via the hose 30 to fill the reservoir 26 via an upper tank fill port 27. The air filtration device 20 is a closed-loop plumbing system that does not require a connection to external plumbing for operating. In this regard, the air filtration device 20 is mobile and can be positioned for ambient or direct air filtration as desired. A set of castor wheels 55 are secured to the base of the air filtration device 20 to facilitate transport and positioning of the device 20. In the embodiment shown in FIGS. 1 to 7, power is received via an electrical plug 58 to power the pump 29, the sensor 53, and the wireless communications module 55. In other embodiments, however, the air filtration device 20 can include a power source such as one or more batteries that may be rechargeable to power operation of the pump for a period of time before recharging is required.

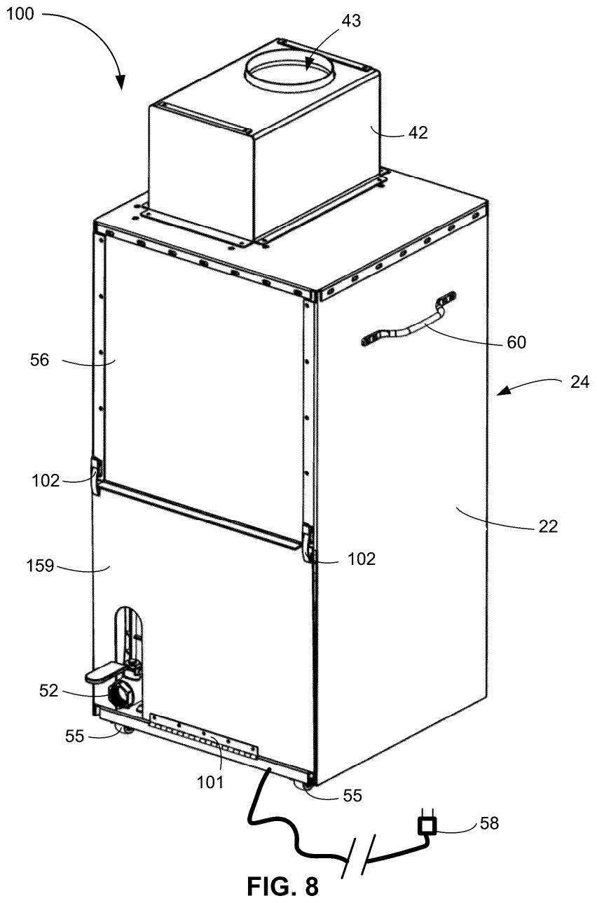

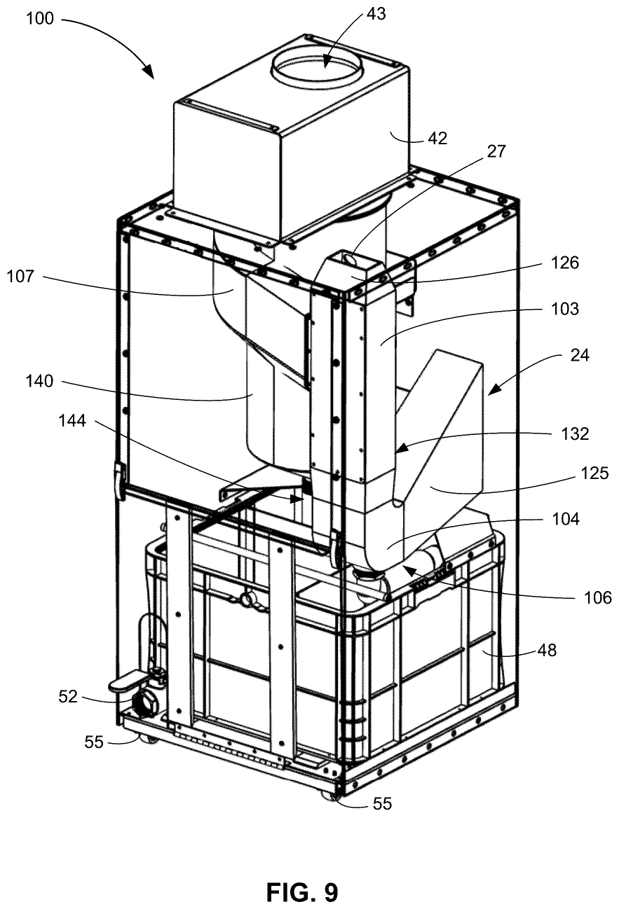

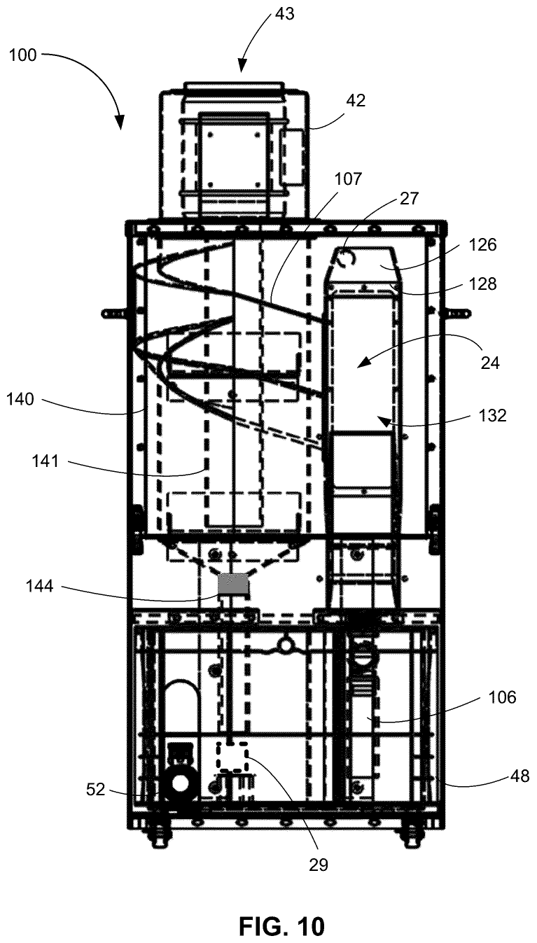

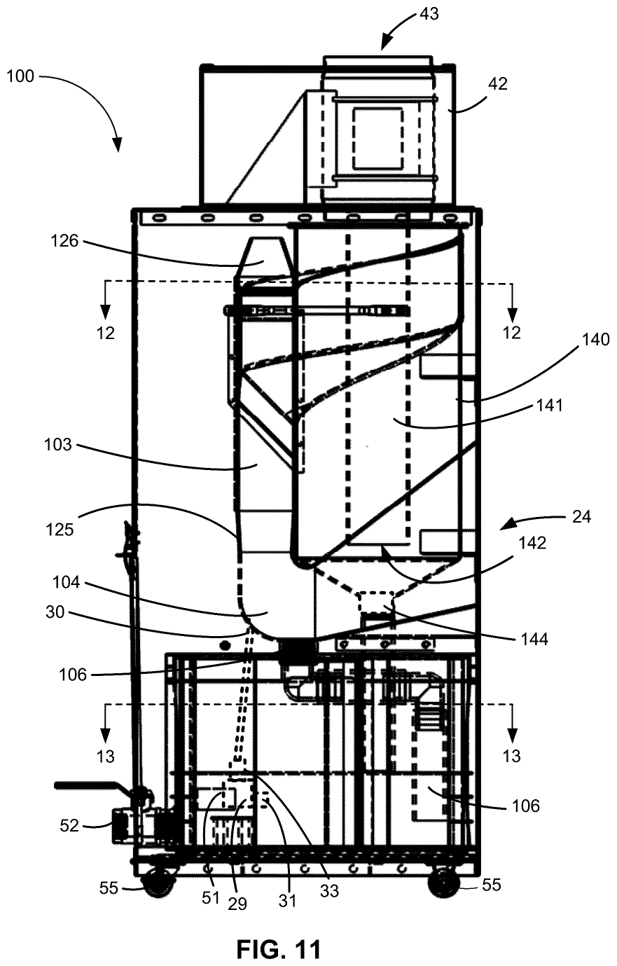

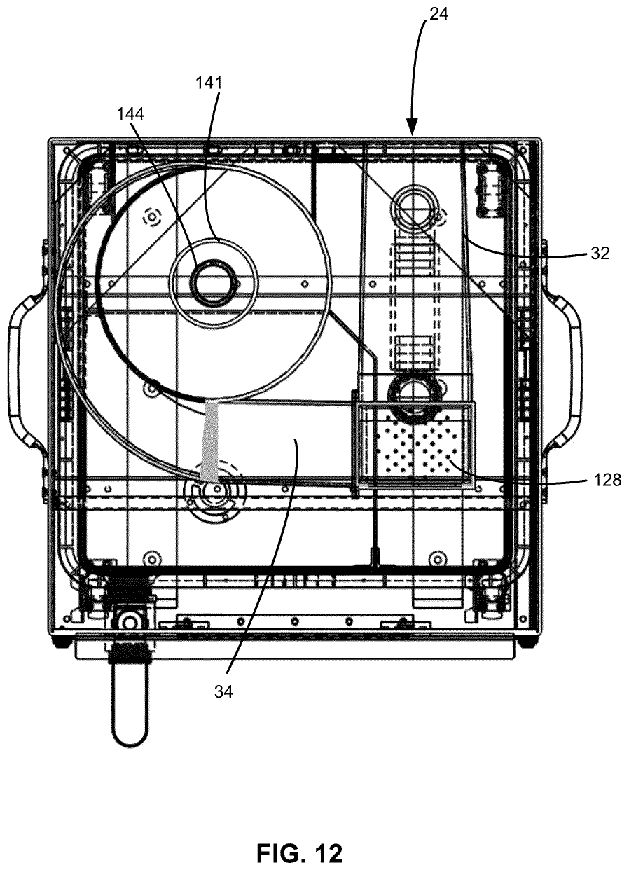

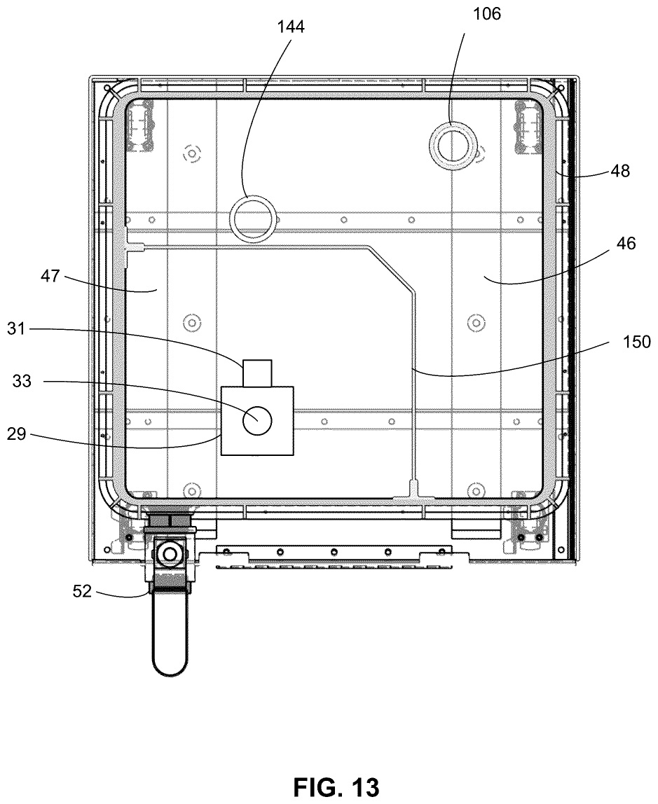

FIGS. 8 to 14 show an air filtration device 100 in accordance with another exemplary embodiment. The air filtration device 100 is similar to the air filtration device 20 of FIGS. 1 to 7, except as described below. Elements of the air filtration device 100 that are similar in design and function to elements of the air filtration device 20 are similarly amended. Further, for elements that are similar in design and function similarly to those previously illustrated and described, the above description can be relied upon and may not be repeated.

An access panel 159 provides access to a bottom portion of the air filtration device 100. In the illustrated embodiment, the access panel 159 opens downwardly via a hinge 101 at the base of the access panel 159. Two clasps 102 alternatively releasably retain the access panel 159 in the closed position as shown in FIG. 8 or can be moved to release the access panel 159 to pivot downwards. A handle 160 facilitates manual repositioning of the air filtration device 100.

Similar to the air filtration device 20 of FIGS. 1 to 7, the air filtration unit 100 has an air conduit 125 that extends downwardly from the air intake 24 to prevent leakage of fluid from the air filtration device 100 from the air intake 24.

A fan unit 42 is positioned towards a downstream end of the air conduit 125 to impel the air through the air conduit 125. The air conduit 125 then bends upwardly at an elbow 104 to a substantially vertical section 103, where treatment water may be introduced in a liquid introduction section 132. In some configurations, the height of the air conduit 125 at the air intake 24 can be larger than the height of the air conduit 125 at the elbow 104, forming a constriction in the air flow pathway, for increasing the velocity of dirty air flow through the elbow 104. In examples, directing air flow through treatment water through the elbow 104 and vertically up the substantially vertical section 103 of the air conduit 125 may expose the dirty air to additional filtration dynamics for effectively removing more pollutants from the dirty air. For example, transitioning the flow pattern from substantially horizontal flow through the elbow 104 that is perpendicular to the flow of treatment water, to substantially vertical flow through the vertical section 103 that is parallel to the flow of treatment water, may assist the removal of pollutants from the dirty air.

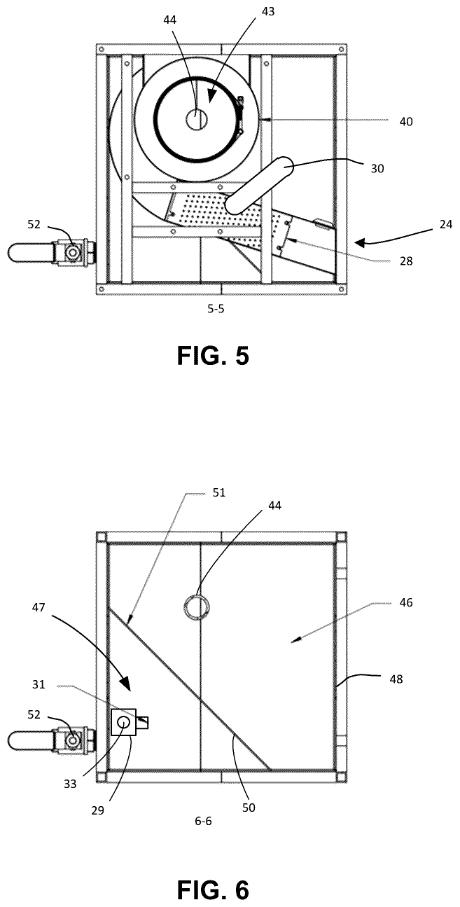

A reservoir 126 for housing a volume of treatment water is positioned towards the top of the substantially vertical section 103 and has a diffusion plate 128 along its bottom. The reservoir 126 is tapered towards its top end to minimize the volume of water housed in the reservoir 126 for flowing through the apertures of the diffusion plate 128, while maintaining coverage over the extent of the diffusion plate 128. However, in some alternative configurations, the side walls of the reservoir 126 may be tapered inward towards a bottom end thereof (e.g., the reservoir 126 may resemble a trapezoidal prism in shape). The diffusion plate 128 is similar to the diffusion plate 28 shown in FIG. 5 in that it has a set of apertures for allowing water in the reservoir 126 to precipitate into the substantially vertical section 103. The diffusion plate 128 may be configured for easy removal or exchange with alternative diffusion plates, for example, for varying the number and size of apertures or slots to enable different levels of precipitation, for example, depending on the application. By positioning the diffusion plate 128 over the substantially vertical section 103 through which air flows upwards, the exposure time between the water and the air is increased to better mix the air and the water.

Gaps along all four lateral edges of the diffusion plate 128 allow water to run down all four internal walls of the substantially vertical section 103 of the air conduit 125 to keep them free of particulate. These gaps can be continuous in some configurations. The long vertical path of the air through the vertical section 103 provides a greater chance to mix with the precipitated water from the reservoir 126. As will be appreciated, some of the water may be vaporized into the air. A drain 106 at the bottom of the elbow 104 enables water to be drained into a water storage tank 48 for recycling. Preferably, the drain is designed to be sealed by water during operation.

The moisture-laden air from the vertical section 103 is then directed into an air bypass 107 spaced upstream of the diffusion plate 128 before being fed into a cyclonic chamber 140 towards its top for removing particle-laden moisture from the air. By placing the entrance of the air bypass 107 upstream of the diffusion plate 128, the seal of the apertures of the diffusion plate 128 is less likely to be disturbed and compromised, thus better ensuring that the flow of water from the apertures in the diffusion plate 128 is not interrupted, and that the airflow to the air bypass 107 is from the vertical section 103 and not the diffusion plate 128. Further, the change in direction of the airflow from generally upward to generally horizontal encourages centrifugal separation of water in the airstream.

The air bypass 107 is also configured to have an inlet that has a substantially larger cross section than that of the liquid introduction section 132 for receiving the air from the vertical section 103 to expand the volume of the air flow pathway and reduce the velocity of the air at the junction between the vertical section 103 and the air bypass 107. Reducing the velocity of the air at the junction between the vertical section 103 and the air bypass 107 can help to minimize any bending effects on the treatment water stream or other interruptions to the flow of the treatment water stream, caused by the fan unit 42 drawing air through the junction. In some configurations, the vertical section 103 may be configured for easy removal or exchange with alternative vertical sections, for example, having varying size and shape or for enabling different levels of filtration, for example, depending on the application. In some embodiments, for example, the vertical section 103 may be removed and/or exchanged through the access panel 159 or the window 56 which may be removable.

The air bypass 107 may be configured to direct the flow of air upwards into the top of the cyclonic chamber 140. The up-gradient slope of the air bypass 107 reduces the water being drawn into the cyclone chamber 140, for example, for optimal functioning of the cyclone chamber 140 and avoidance of potential flooding or blockage. The upward gradient of the air bypass 107 also serves to direct any treatment water drawn into the air bypass 107, back to the liquid introduction section 132 where the water is drained via the drain 106. The air bypass 107 also directs the flow of air away from the diffusion plate 128 to maintain a vacuum seal within the closed-loop plumbing system of the air filtration device 100 and to prevent air from entering the reservoir 126 or the hose 30 used to replenish the water in the reservoir 126, among other components of the closed-loop plumbing system. In directing the flow of air away from the diffusion plate 128, the air bypass 107 may also reduce pressure on the diffusion plate 128, for example, potentially pushing dirty air into the reservoir 128 and breaking the vacuum seal within the closed-loop plumbing system of the air filtration device 100.

The air then follows a helical path towards the bottom of the cyclonic chamber 140 around a central exhaust conduit 141, causing the particle-laden moisture to be spun towards the walls of the cyclonic chamber 140 and flow down the walls towards and down a cyclone chamber drain pipe 144 positioned at a bottom end of the cyclonic chamber 140. The air flows through an opening 142 towards the lower end of the exhaust conduit 141 and upwards through the exhaust conduit 141 towards and out of the air outlet 43. The central exhaust conduit 141 can enhance the centrifugal separation of particle-laden water from the air stream by constraining the flow of the air along the outer wall of cyclonic chamber 140.

The cyclone chamber drain pipe 144 is configured to be connected to the drain 106 via one-way check valve continually submerged in the dirty water area 46 of the water storage tank 48 for ensuring a vacuum seal within the closed-loop plumbing system of the air filtration device 100. Having both the cyclone chamber drain pipe 144 and the drain 106 joined may ease servicing by enabling the removal of just one pipe instead of two during maintenance.

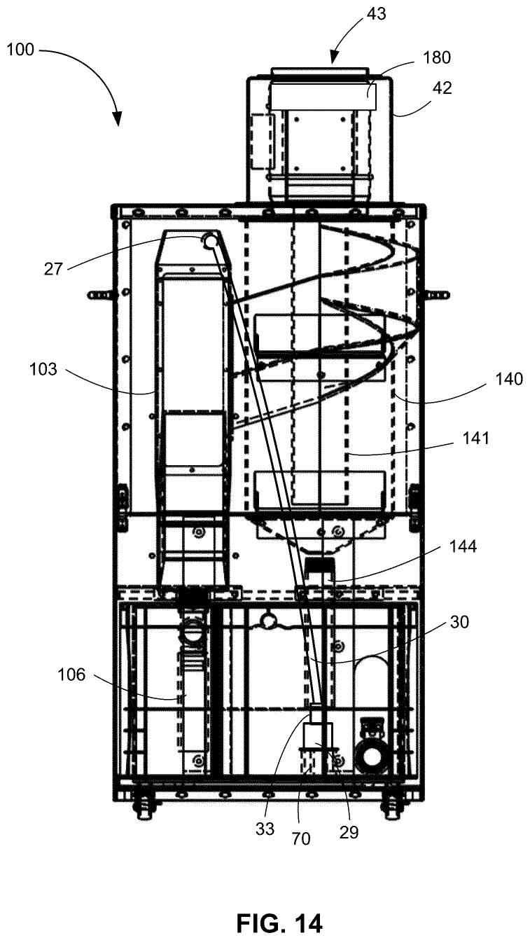

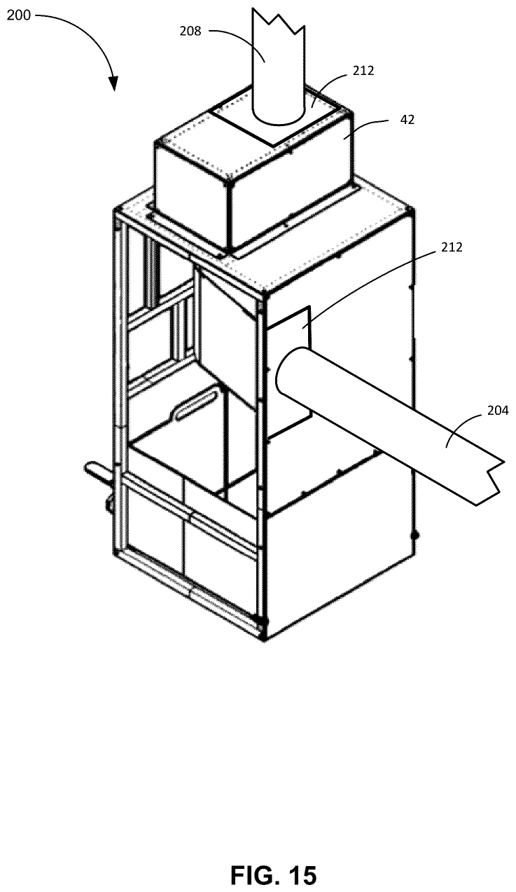

An optional carbon filter 180 is shown in FIG. 14 installed downstream of the liquid introduction section 132 for enhanced removal pollutants (e.g., VOC's, odors, fumes, smoke, etc.). In the illustrated configuration, the carbon filter 180 is installed at the air outlet 43.

It may be desirable to include additional stages of mixing water with the contaminated air in some scenarios. For example, the air can be introduced to water such as via a liquid introduction section similar to the liquid introduction section 32 and then guided through another cyclonic chamber similar to the cyclonic chamber 40 to remove the water.

FIG. 15 shows a top, front, right side isometric view of a wet air filtration device 200 in accordance with a further example embodiment of the present disclosure. The wet air filtration device 200 is coupled to an intake duct 204 and to an output duct 208 via duct adapters 212 of the wet air filtration device 200. The duct adapters 212 can be formed integrally with the housing of the wet air filtration device 200 or can be coupled to the wet air filtration device 200 in any suitable manner, such as bolting. By coupling directly to intake and/or output ducts, the air being filtered can be more specifically targeted, and the output air can be recirculated in a targeted manner.

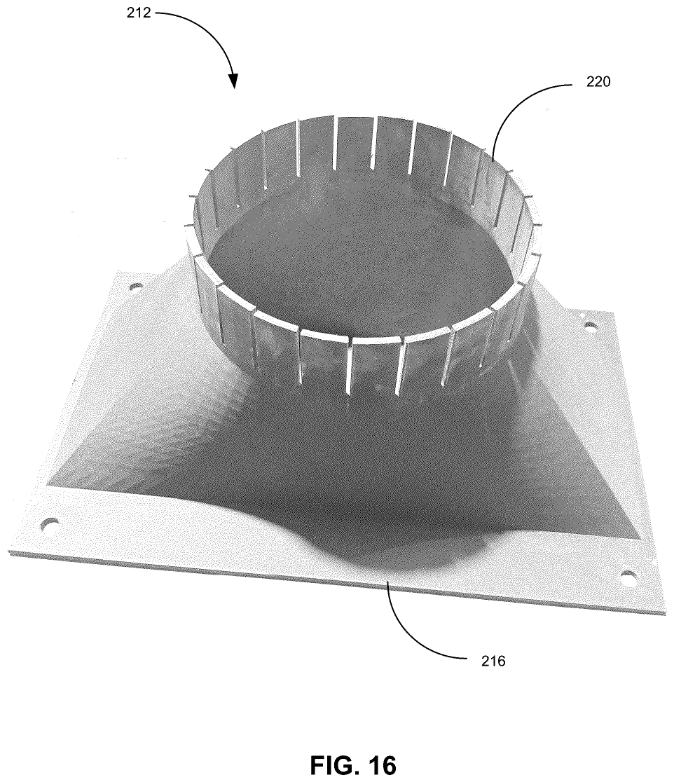

FIG. 16 shows an exemplary duct adapter 212 used to connect ducts to the wet air filtration device 200 of FIG. 15. The duct adapters 212 are designed to be coupled to the housing of the wet air filtration device 200 via bolts, but can be secured to the wet air filtration device 200 in any other suitable manner. A base plate 216 of the duct adapter 212 is designed to be secured to the housing of the wet air filtration device 200 to provide a sealed connection. This can be achieved via any suitable means, such as bolting. A pliable sealing member, such as an o-ring or the like, can be positioned between the housing and the duct adapter 212 to seal the connection between the duct adapter 212 and the air intake or air outlet. A flanged receiver 220 extends from the base plate 216 to securely receive the ducts 204, 208 when an end of the duct is fitted thereover. Duct tape or any other suitable sealant can then be applied to create a seal between the duct and the duct adapter 212. Preferably, the duct adapter 212 is releasably securable to a duct.

While in the above-described and illustrated embodiments, the liquid used to filter the air is water, any other suitable liquid can be used.

Although the present disclosure describes methods and processes with steps in a certain order, one or more steps of the methods and processes may be omitted or altered as appropriate. One or more steps may take place in an order other than that in which they are described, as appropriate.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. An air filtration device comprising:
a housing having an air intake and an air outlet;
an air conduit extending between the air intake and the air outlet; and
a fan positioned in the air conduit and configured to draw air into the device via the air intake and propel the air through an air channel towards the air outlet,
wherein the air conduit includes a liquid introduction section configured to introduce a liquid to the air in the air channel, and a liquid removal section configured to guide the air in a downward helical path downstream of the liquid introduction section to separate the liquid from the air using centrifugal force.

2. The air filtration device of claim 1, further comprising a reservoir positioned above the liquid introduction section, the reservoir having a plurality of apertures configured to allow the fluid to precipitate from the reservoir into the air in the air channel.

3. The air filtration device of claim 2, wherein the reservoir is tapered towards an upper end thereof.

4. The air filtration device of claim 2, wherein the reservoir includes at least one aperture or gap towards opposite interior lateral sides of the air conduit configured to allow the liquid to flow along the interior lateral sides of the conduit.

5. The air filtration device of claim 4, wherein the reservoir includes a diffusion plate positioned adjacent to the air channel having the at least one aperture.

6. The air filtration device of claim 2, wherein the plurality of apertures are positioned to introduce the liquid into the liquid introduction section of the air conduit in which the air is moved substantially upwards.

7. The air filtration device of claim 6, wherein a bypass section extends from the liquid introduction section spaced from the plurality of apertures, and to the liquid removal section.

8. The air filtration device of claim 7, wherein an ingress of the bypass section from the liquid introduction section has a cross section that is greater than a cross section of the liquid introduction section.

9. The air filtration device of claim 6, wherein a drain conduit extends from a lower end of the liquid introduction section to return the liquid removed from the air in the liquid introduction section to the liquid tank.

10. The air filtration device of claim 2, wherein a liquid tank is positioned to receive the liquid separated from the air, and a pump is configured to draw the liquid from the liquid tank and into the reservoir.

11. The air filtration device of claim 10, wherein the liquid tank is removable from the housing.

12. The air filtration device of claim 10, wherein the liquid tank includes a baffle separating a dirty liquid area from a clarified water area, wherein the baffle is configured to allow the liquid towards the top of the dirty liquid area to flow into the clarified liquid area, and wherein a pump is positioned in the clarified liquid area to move the liquid therein to the reservoir.

13. The air filtration device of claim 12, further comprising a silt sensor positioned to measure a silt level in the liquid in the liquid tank.

14. The air filtration device of claim 13, further comprising an audio or visual notification device configured to notify when the silt level is at least at a threshold value.

15. The air filtration device of claim 13, further comprising a wireless communications module configured to transmit a notification when the silt level is at least at a threshold value.

16. The air filtration device of claim 1, wherein the air channel defined by the air conduit extends downwardly from the air intake.

17. The air filtration device of claim 1, wherein the liquid introduction section defines an upward path for the air travelling in the air channel from the air intake to the air outlet.

18. The air filtration device of claim 1, wherein a drain conduit extends from a lower end of the liquid removal section to return the liquid removed from the air in the liquid removal section to the liquid tank.

19. The air filtration device of claim 18, wherein the plurality of apertures are positioned to introduce the liquid into the liquid introduction section of the air conduit in which the air is moved substantially upwards, wherein a drain conduit extends from a lower end of the liquid introduction section to return the liquid removed from the air in the liquid introduction section to the liquid tank, and wherein the drain conduit extending from a lower end of the liquid removal section is joined to the drain conduit extending from a lower end of the liquid removal section via a one-way check valve to maintain a vacuum seal.

20. The air filtration device of claim 1, wherein the liquid removal section includes a chamber having an arcuate interior wall configured to direct the air along a helical path.

21. The air filtration device of claim 20, wherein an exhaust conduit extends centrally from the air outlet downwards in the chamber, and has an opening towards a lower end thereof configured to receive the air.

22. The air filtration device of claim 10, wherein the liquid tank includes a baffle defining a dirty liquid section and a clarified liquid section, wherein the liquid separated from the air is returned to the dirty liquid section of the liquid tank, and wherein the baffle is configured to allow the liquid in the dirty liquid section to overflow into the clarified liquid section.

23. The air filtration device of claim 1, further comprising a set of wheels connected to the housing configured to facilitate relocation of the air filtration device.

24. The air filtration device of claim 1, further comprising a duct adapter for securely coupling a duct to one of the air intake and the air outlet.
